(19) United States
(12) Patent Application Publication
(10) Pub. No.: US 2015/0006407 A1
(43) Pub. Date: Jan. 1, 2015

(54) SYSTEMS, METHODS, AND COMPUTER PROGRAM PRODUCTS PROVIDING PAYMENT IN COOPERATION WITH EMV CARD READERS

(71) Applicant: EBAY INC., San Jose, CA (US)

(72) Inventors: John Lunn, San Jose, CA (US); Narik Patel, San Jose, CA (US); Ali Minaei Moghadam, San Jose, CA (US); Sivanne Goldfarb, San Jose, CA (US)

(21) Appl. No.: 14/371,977

(22) PCT Filed: Jan. 11, 2013
(86) PCT No.: PCT/US2013/021253

§ 371 Date: Jul. 11, 2014

Related U.S. Application Data
(60) Provisional application No. 61/586,314, filed on Jan. 13, 2012.

(51) Int. Cl. G06Q 20/40; G06Q 20/32; G06Q 20/34; G06Q 20/18

(52) U.S. Cl. CPC G06Q 20/4018; G06Q 20/18; G06Q 20/3226; G06Q 20/34
USPC 705/73

(57) ABSTRACT

An electronic payment system provided by a mobile communication device, the system including a memory storing instructions for interacting with a EMV card reader to cause payment from an issuing bank associated with a cardholder to an acquiring bank of a merchant associated with the electronic payment processing system; and one or more processors in communication with the memory configured to: initiate a transaction by passing transaction information, including a transaction amount, to the EMV card reader; receive encrypted payment authorization from the EMV card reader to process a payment from the issuing bank to the acquiring bank, wherein the one or more processors are in communication with the EMV card reader; pass the encrypted payment authorization to the acquiring bank over a data connection; and receive a confirmation of payment from the acquiring bank over the data connection.

### CROSS-REFERENCE TO RELATED APPLICATIONS

The present application claims priority to U.S. Patent Provisional Application Ser. No. 61/586,314, filed Jan. 13, 2012, which is incorporated herein by reference as part of the present disclosure.

### BACKGROUND

1. Technical Field

The present disclosure generally relates to making payments with an EMV card reader, and more particularly, to devices and techniques for enabling a scalable, centralised online payment system to operate with EMV card readers in accepting payments via large, widely available, open networks such as the Internet.

2. Related Art

It is common for consumers and businesses to have electronically accessed accounts with financial institutions to send and receive payments from other parties. One example includes payment cards, which are typically used electronically and transfer money electronically. Another example is a third party payment provider, such as that offered under the name PayPal™, which processes payments between users who pay and receive funds to and from multiple sources such as payment cards, bank accounts, and other sources of funds for payment.

These methods of payment, whether electronic or otherwise, carry a risk of fraud. For instance, in the United States (US) and the other relatively few jurisdictions that do not use EMV cards, the typical use scenario for a credit card is for the card to have a magnetic stripe that records the credit card number, expiration date, etc., where the stripe is readable by a simple magnetic sensor and decoder so that a human user does not have to enter the recorded information (card number, expiration date) manually. However, merely encoding information on a magnetic stripe provides little security, as a thief only has to decode the information using readily and publicly available algorithms to obtain the information on the stripe to nefariously use the cardholder's account, or the same information can simply be read from the front of the card. Manual signatures, as used in the US for authenticating card payments, provide little security to the US system because merchants have only inadequate means of verifying signatures against examples known to be authentic. There is no means in the US of ensuring that the signature on the back of the card is indeed that of the card holder, and merchants often do not check the signature authorizing the payment against the one on the back of the card. US banks, including acquiring banks, generally do not actually use the manual signature on a card payment authorization as a means of authentication because they do not verify the signature at all. No generally accepted or rigorous methodology is in use for determining whether two manual signatures were made by the same person; authentication depends entirely on whether the sales clerk checks the signature on the authorization against the signature on the bank of the card, which is presumed authentic but may not be so if the card has been stolen, and on whether the sales clerk is capable of detecting a forgery if one is present.

By contrast, Europe and other countries have adopted a protocol that uses EMV cards (also known as Chip and PIN cards or smartcards) and offers enhanced security. EMV-cards and card readers are defined according to the following EMV standards: EMV Integrated Circuit Card Specifications for Payment Systems, version 4.2, June 2008 (EMVCo LLC); Type Approval Process Documentation for terminals and cards available from EMVCo LLC; EMV Security Guidelines, version 4.0, December 2010 (EMVCo LLC). Cards that conform to EMV standards using a processor on a card are referred to in the following examples as EMV cards or EMV compliant cards, and card readers conforming to the EMV standards to communicate with processors on cards are referred to as EMV card readers or EMV compliant card readers. EMV cards are smartcards, i.e. they have a chip (a microprocessor) built in to the card and a secure storage capability. The cards are designed to use public key cryptography for encryption and authentication of messages sent to authorize payments. The card securely stores a private key that does not leave the card and whose usage is carefully controlled. To use the card, the cardholder inserts the card into a card reader that includes a keypad for secure entry of a Personal Identification Number (PIN) as well as support for other means of verifying the cardholder's identity.

In conventional usage, the EMV card reader communicates with a local point of sale (POS) system that in turn connects to a server at the merchant's acquirer. Accepting a card payment involves messaging between the card reader, the merchant's POS system, and the server at the acquirer, and the critical messages are digitally authenticated and encrypted (at least in part by the private key stored in the card). The authorization for the payment is digitally signed and encrypted using the private key on the card, and is then passed by the merchant's POS system to the acquirer, who sends it on to the issuer, whose server decrypts the authorization message and verifies its authentication. Verification of the digital authentication of the critical messages ensures that the payment authorization was made using the private key stored securely on the card, that the card (and its key) were validly issued to an identified card holder by the issuer (the card holder's bank), and consequently, it is difficult for the card holder to repudiate the authorization. It is also difficult for someone other than the card holder to access the private key that authenticates the authorization (such access requires entry of a PIN with a limited number of tries or another method of verifying cardholder identity) and create forged authorizations. Introduction of EMV cards in Europe resulted in a significant drop in the rate of card fraud from the prior system using manual signatures for authentication.

Conventional EMV card readers are about the size of a brick, and they range up to quite large and heavy particularly when designed to be portable. Portable devices incorporate wireless communications, a battery, and a printer, so they are usually several centimeters larger than a brick and significantly heavier than non-portable EMV devices. Conventional EMV card readers include not only circuitry to power the card and the processor in the card, but also the PIN pad and a small screen, and they form messages that are transmitted eventually to the acquirer's server, normally via a retailer's point of sale (POS) system. Smaller devices tend to be tethered by a cable to a cash register that forms part of a POS. Furthermore, conventional EMV card readers may include a printer and a power supply. The power supply, screen, keypad, and printer all add to the bulk of the device.

Conventional EMV card readers become larger and heavier when designed for portability. Because conventional portable readers are 15-20 times the size of a smartphone, they are not suitable for use wherever smartphones can easily go. Rather, conventional EMV card readers communicate with a POS system, which usually includes one or more large computers with terminals built into a cashiers' stations and communicating with the back-office POS system. The POS system tethers conventional EMV readers to a local area, where Wi Fi or cable connections to the POS system are possible. As a result, professionals in the field, such as plumbers, are not able to take payment by credit card because it is not convenient to carry around a POS system, or even a conventional reader. The retail checkout experience normally involves queuing at fixed terminals in order for sales to be entered into the POS system; the checkout experience occurs only at fixed points where large POS terminals are installed and sales cannot occur elsewhere in the store where a buyer and a sales assistant meet or where purchase decisions are made.

### BRIEF DESCRIPTION OF THE DRAWINGS

FIG. 1 illustrates a system for transaction of funds between two parties using a EMV card according to example embodiments.

FIG. 2 is a simplified diagram of an example system for making payments from a payment provider 208 to a merchant's account.

FIG. 3 is a signal diagram of communications that may be carried out in the configuration of FIG. 2.

FIGS. 4-6 illustrate example information displayed upon a screen of a mobile communication device according to one embodiment.

FIGS. 7 and 8 illustrate example methods to make payment according to one embodiment.

FIGS. 9 and 10 illustrate a block diagrams of computer systems for implementing various methods and devices described according to various aspects of the present disclosure.

FIG. 11 illustrates a block diagram of a computer system for implementing various methods and devices described according to various aspects of the present disclosure.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting.

According to the various aspects of the present disclosure, a method, system, and computer program product are discussed below that use a EMV card reader to make and accept payment for a transaction. In one example, a merchant has a highly portable, minimized EMV card reader that connects wirelessly with a handheld communication device, such as a smartphone or tablet computer. The handheld communication device has a library of Application Programming Interfaces (APIs) that enable an application running on the handheld communication device to communicate with the EMV card reader to initiate a transaction, pass data about the amount and payee for use in forming an authorization, and to pass payment authorization from the card reader to a payment service provider. The application interacting with the card reader also governs the reader's operation (its connection with the handheld communication device, battery power status, authentication of the device to the server supporting it, and re-keying and resetting of the device).

The application running on the handheld communication device interfaces with one or more servers at one or more payment providers. For instance, the merchant may be associated with a third party payment service provider, such as PayPal In such a case, the card reader may pass payment authorization to the handheld communication device, which uses its library of APIs to pass the payment authorization and other information to the payment service provider for processing. The payment service provider then passes a message, including the digitally authenticated payment authorization, to a card transaction acquirer to request payment. The acquirer passes the authorization to the card issuer, which responds by processing the authorization and either approving or refusing payment in the manner prescribed by the relevant card association, and notifying the acquirer accordingly. The acquirer registers the issuer's response, the acquirer either accepts or declines the payment, it notifies and eventually credits the payment service provider, which passes the credit through to the merchant's account with the payment service provider.

In some embodiments, the conventional EMV card reader has been split into two devices, a minimalist reader that only does the functions that a reader and no other device is allowed to do (e.g., the PKI functions), and an interface device. The minimalist reader can be much smaller because it uses the handheld communication device for the interface functions (display, print) except showing entry of PIN digits. The minimalist reader is not online—its only communication capability is with the handheld communication device to which it is paired, and it will only communicate with the handheld communication device via a secure means (e.g., Bluetooth). The limited connectivity helps protect the security of the card reader. Using a phone or tablet for the user interface and online communications re-uses the phone's (or tablet's) existing capabilities (rather than duplicating them in the secure device, thereby making it less secure, more expensive, and bulkier). PayPal, a payment services provider, replaces the POS system, which is site-based whereas PayPal is available wherever and whenever the Internet can be accessed. The result is less cost, less bulk, much greater portability, with replaceable and interchangeable components.

Thus, in one aspect, the payment services provider (via the application on the handheld communication device) performs the role of the conventional merchant POS system. For instance, in some embodiments, the payment services provider operates the EMV reader and interfaces with the EMV reader by prompting users to insert cards, showing amount to be paid and requesting PIN entry (or other user authentication) by the cardholder, dealing with errors from the EMV process, and the like. Furthermore, the payment services provider (via the application) may also: record the cardholder's authorisation as received from the EMV reader, along with other data from the payment transaction (amount, currency, date, buyer, link to sale transaction, etc.), pass the authorisation and other data to the acquirer, manage the payment clearing process through to eventual settlement, refund payments back to cards (where cards are reinserted into the EMV reader), and process chargebacks, and the like. By transferring these functions from the merchant's site-based POS system to the merchant's online payment services provider, card payment acceptance ceases to be tethered to a specific site. It becomes available wherever the Internet can be accessed.

Some embodiments include a simple card reader that provides the minimum functionality called for by the EMV standards. For instance, the card reader may power the card, facilitate PIN entry and perhaps other means of cardholder verification, and form messages that get signed and encrypted by the card and sent on via the handheld communication device to the payment service provider and eventually to the acquirer. Other functionality to complete the transaction is included in the application at the handheld communication device. Thus, in one example, the card reader does not include the usual LCD display or a printer, instead relying on the handheld communication device to provide a screen and a copy in a durable medium. The card reader may employ Light Emitting Diodes (LEDs) to indicate when a digit of a PIN has been entered, or may use another reliable button-depression indicator such as an audible beep, and rely on the handheld communication device for all other interaction with the payer.

In one working example, a payer has an payment card, such as a debit card or a credit card. The payer can use the card to pay for transactions using an EMV card reader, a handheld communication device running a prescribed application, and a payment service provider serving the payee. Merchants have accounts with payment service providers where they receive payments from card holders. The payment service provider provides the app running on the handheld communication device and operating the reader, as well as operational support to carry out the transaction. In a consumer transaction scenario, the consumer pays a merchant by presenting his or her card to the merchant, where the merchant uses the consumer's card to receive payment at a payment service provider. The payment service provider processes the payment by having an acquirer obtain funds from the card holder's bank and then passing those funds through to the payment service provider, who credits the merchant's account.

In one working example, a consumer (customer) at a restaurant (a merchant) is ready to pay the bill. The waiter has both a handheld communication device running a payment application and a small, highly portable EMV card reader. The handheld communication device is in wireless communication with the card reader via Bluetooth or some other appropriate means that provides secure one-to-one pairing. The amount of the bill is entered into the handheld communication device by communication with a POS or, perhaps, manually by the waiter. The waiter shows the customer the display screen of the phone that prominently shows the total to be paid. The customer then inserts a EMV card into the card reader, and the phone prompts the customer to enter the PIN (or other cardholder verification), which the customer does. Entry of the PIN digits is shown on the device using LEDs (or another user feedback technique), but the phone is not aware of PIN entry. The card reader requires the PIN (or other cardholder verification) to access the private key stored on the card, and the card uses the private key to digitally sign an authorisation message indicating how much to pay from the card holder's account to the merchant. The card reader then encrypts the payment authorization message and communicates it to the handheld communication device. The card then returns the private key to its secure storage medium. The handheld communication device uses its data link (e.g., Bluetooth) to receive the encrypted payment authorization from the reader and uses a second data connection (e.g., Wi-Fi or a cellular data connection) pass it on to a payment service provider (PSP, e.g., PayPal) over the Internet or other network. The PSP passes the payment authorisation through to an acquirer, which obtains funds from the card holder's account and passes those funds back to the payment service provider for the account of the merchant. After crediting the merchant's account with the PSP, the PSP sends a confirmation back to the handheld communication device. The handheld communication device then displays a message that the transaction is complete and that the cardholder should remove the card from the reader. If desired, the cardholder or waiter can enter an email or Multimedia Messaging Service (MMS) address into the handheld communication device to send an electronic receipt to the cardholder.

The example above provides advantages over conventional EMV card reader schemes. For instance, whereas conventional card readers are ordinarily usable only on the same site as a non-portable POS system, the example above includes two small, portable devices—the handheld communication device and the minimal card reader, and they communicate over universally accessible public networks with a scalable server at a PSP that is always online and available for service. Accordingly, anyone with a handheld communication device that has a data connection can take an EMV card payment from any location where public data networks are accessible over mobile networks. For example, plumbers and other people on the go can take payment by EMV card without having to have a POS system, and people with a POS system can take payments offsite or in store without queuing at POS terminals. Thus, some embodiments greatly increase the workable scenarios for taking card payments. Nevertheless, various embodiments may include the application on the handheld communication device or at the payment service provider having the ability to couple to a POS system when convenient.

The scope of embodiments is not limited to restaurants or plumbers. Other examples may include any kind of merchant or charity receiving payment from a cardholder. Furthermore, various embodiments will also generally include processing refunds to the cardholder, disabling or flagging stolen cards, and error handling.

The embodiment just described, or other embodiments, could employ alternative means (besides PIN entry) to confirm the identity of the person attempting to pay. The EMV standards (EMV Integrated Circuit Card Specifications for Payment Systems: Book 3, Application Specification, section 10.5 (November 2011)) define several “cardholder verification methods). Entering the correct PIN is one method of verifying that the person producing the card in order to pay is the person to whom the issuer issued the card. The PIN may be stored online, or offline on the card itself, in either encrypted or plaintext form. Instead of a PIN, the cardholder verification may take the form of a handwritten signature or other authentication not verifiable by digital means. EMV standards require that the chip on the card process restrictions, including restrictions on the cardholder verification methods allowed for the card. EMV standards also allow the use of cards that have no chips on them at all. EMV card readers commonly include a magnetic stripe reader to assist in reading cards that have no chips and no digital data storage capability other than the magnetic stripe.

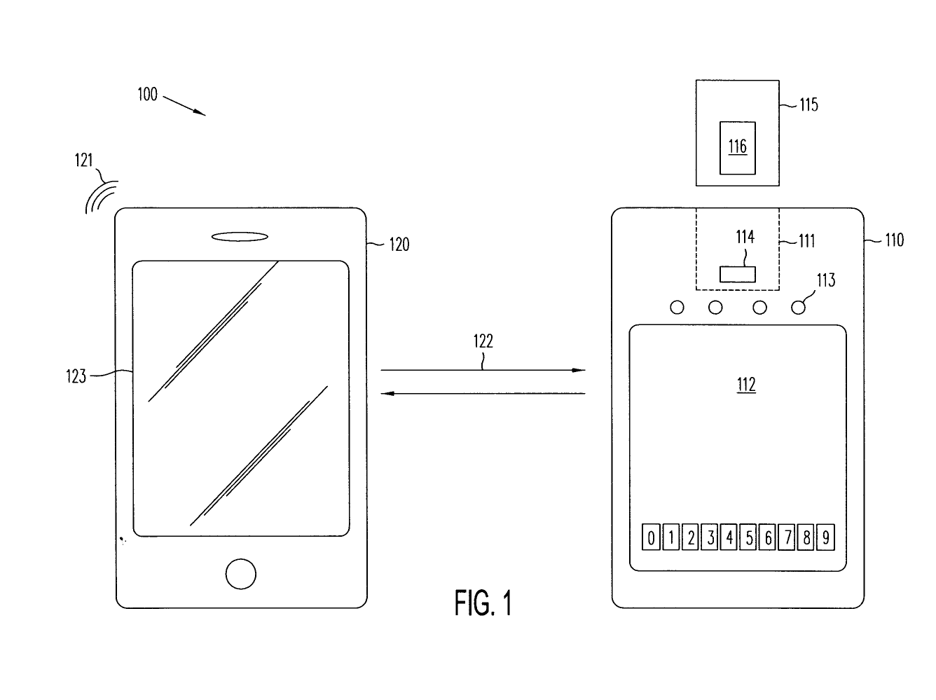

FIG. 1 is an illustration of example system 100, adapted according to one embodiment. System 100 includes EMV card reader 110 and handheld communication device 120. Card reader 110 is a processor-based device that includes keypad 112, LED display 113, and card slot 111. A cardholder may insert EMV card 115 into card slot 111, which includes contacts 114. Card 115 is then electrically coupled with contacts 114 to facilitate data communication between a processor (not shown) in card reader 110 and processor 116 of card 115. Other embodiments provide for a contactless coupling between card reader 110 and card 115 (e.g., by Near Field Communication, NFC).

Instead of having a full display, reader 110 includes LEDs 113. As a user enters digits on keypad 112, LEDs 113 successively light up with each key stroke to indicate to the user how many digits have been entered. Of course, the LED arrangement of FIG. 1 is just an example, as any appropriate keystroke indicator may be used in other embodiments.

Although not shown in FIG. 1, reader 110 includes software or firmware therein to control its operation, allowing it to receive keystrokes, activate the private key (not shown) and return it to secure storage on the card (not shown), read other data from the card 115, interact with communication device 120, perform cryptographic functions such as digital signing and encryption, and the like. Reader 110 also includes a wireless transceiver (not shown) allowing it to communicate with communication device 120 over data connection 122. Data connection 122 may include any appropriate wireless connection, such as a Bluetooth connection, or other secure one-to-one pairing. In this example, card reader 110 does not have its own Internet connection, instead relying on communication device 120 to pass data over the Internet or other network.

Handheld communication device 120 can include any appropriate network-connected mobile device, such as a smartphone, tablet computer, or the like. Communication device 120 is a processor-based device that includes display screen 123, which may be a touchscreen for inputting information. Although not shown here, communication device 120 may include any appropriate user interface device, such as a keyboard, buttons, and the like. Communication device 120 also includes one or more transceivers (not shown) to provide data connections 121 and 122. Data connection 121 is used by communication device 120 to connect to a data network, such as the Internet, an intranet, or other network. In this example, data connection 121 may conform to a same or different protocol as data connection 122. For instance, data connection 121 may be a cellular data connection (e.g., 3G or 4G LTE connection) a Wi-Fi connection, and or the like. Connections 121, 122 may conform to any appropriate protocol.

A person operating communication device 120 (e.g., an employee of a merchant) may access an interface on communication device 120 through a specialized application or other appropriate technique. For instance, a user may download application software programs, also known as “apps” or “applications” to the device 120. In general, applications are computer software programs designed to execute specific tasks. As examples, Apple's® App Store, Microsoft's Windows® Store, and Google's Android Market® are examples of Internet stores that offer a multitude of applications, including entertainment programs, business applications, file management tools, and other widgets, etc.

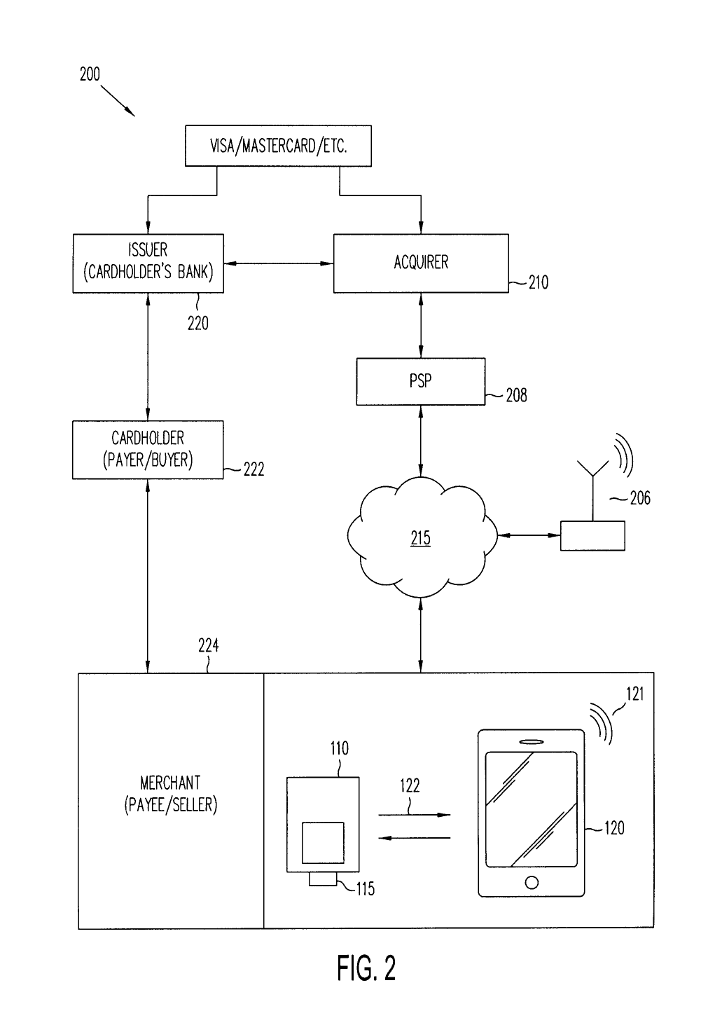

FIG. 2 is a simplified diagram of an example system 200 making payments which are ultimately derived from issuer bank 220 to the merchant's account at a payment service provider 208. Funds to cover the payment are obtained from the cardholder 222 via the issuer 220 (the cardholder's bank) and the acquirer 210 according to protocols and rules established by the relevant card association. In this scenario a merchant, charity, or other entity 224 desiring payment is using devices 120 and 110. The handheld communication device 120 has data transfer capability via public networks and is able to process messages and information between multiple systems. The handheld communication device 120 may communicate over a networked system, such as over the Internet, or through a local area network or cellular network.

PSP 208 is between the acquirer 210 and the merchant 224. PSP 208 has a relationship with both acquirer 210 and merchant 224, but merchant 224 does not have a relationship with the acquirer 210 (as a practical matter—formally and contractually, yes, but only as a legal technicality). The acquirer 210 is under contract with PSP 208, and the merchant 224 is served by PSP 208 rather than by the acquirer 210. The PSP 208 provides the software (not shown) that operates the card reader 110 for the merchant. That software including both of the application running on the handheld communication device 120 and server applications operated by the PSP 208 that drive the device application, handle messaging with the acquirer 210, maintain a database of payment amounts and status, and manage the flow of settlement funds to the merchant. The PSP 208 also has visibility of the goods or services being paid for and assists in resolving any disputes that develop between the payer and payee or which involve payment regulators (anti money laundering authorities, sanctions regimes, etc.).

To make a payment, the cardholder 222 presents a card 115 and inserts it into the reader 110. The cardholder 222 reviews the amount to be paid, which is displayed on communication device 120, and then enters the PIN into the keypad on the reader 110. The PIN releases the private key on the card 115, which authenticates and encrypts an authorization message. The card reader 110 wraps and encrypts the message in a second message. The communication device 120 sends the second message to PSP 208, then to the acquirer 210, and ultimately to the issuer 220. The card schemes define the roles of issuer and acquirer, and they enforce relationship limits that have certain people talking only to certain people. The system must operate within these prescribed limits; for instance, the issuer 220 allows the payment and confirms the payment in a message to the acquirer 208; the acquirer 208 passes the message on to PSP 210, and PSP passes the message to the merchant 224.

Further, as shown in FIG. 2, handheld communication device 120 has capability to communicate via network 215 (e.g., the Internet, a cellular network, and/or the like) wirelessly. Handheld communication device 120 is illustrated communicating through wireless base station 206, which may be a Wi-Fi access point, a cellular tower, or other facility. Thus, handheld communication device 120 may communicate wirelessly with both the PSP 208 and the acquiring bank 210.

The example of FIG. 2 shows payment messages from the merchant being processed by PSP 208 before being transmitted to the acquiring bank 210. In such a scenario, PSP 208 processes the payment using services from the acquirer 210. The acquirer 210 uses card networks and protocols to obtain payment from the issuer 220, which debits the card holder's account, and then the acquirer 210 passes the proceeds to the PSP 208 for crediting to the merchant payee 224. In some embodiments, the PSP 208 may also act as the acquirer 210; the two roles can be merged and performed by the same entity.

In some embodiments, PSP 208 may host an account for the merchant 224 itself and may hold the proceeds of card payments in the merchant's account with the PSP 208. In such an embodiment, PSP 208 may not pass a message on to acquiring bank 210 because PSP 208 is itself performing the functions of an acquirer 210.

Continuing with FIG. 2, when handheld communication device 120 has a network connection either by Wi-Fi or cell phone carrier, an application on handheld communication device 120 can request PSP's 208 servers to process payment. For instance, during a transaction, the merchant 224 may cause the application on handheld communication device 120 to send appropriate information to PSP 208 to schedule the payment. Such appropriate information may include, but is not limited to, an encrypted payment authorization from card 115, the merchant's account credentials, a merchant identification, electronic contact information of the merchant, a transaction amount, a description of the transaction (e.g., type of goods or services sold and a transaction identification number), and/or the like. Furthermore, to complete the transaction, the PSP 208 may communicate over network 215 to provide a transaction confirmation message to handheld communication device 120.

The communication among the entities 208, 210, 220 may be implemented in a variety of ways. In practice, card associations such as Visa and Mastercard define the roles of acquirers 210 and issuers 220, and they prescribe how those roles interact and process payments.

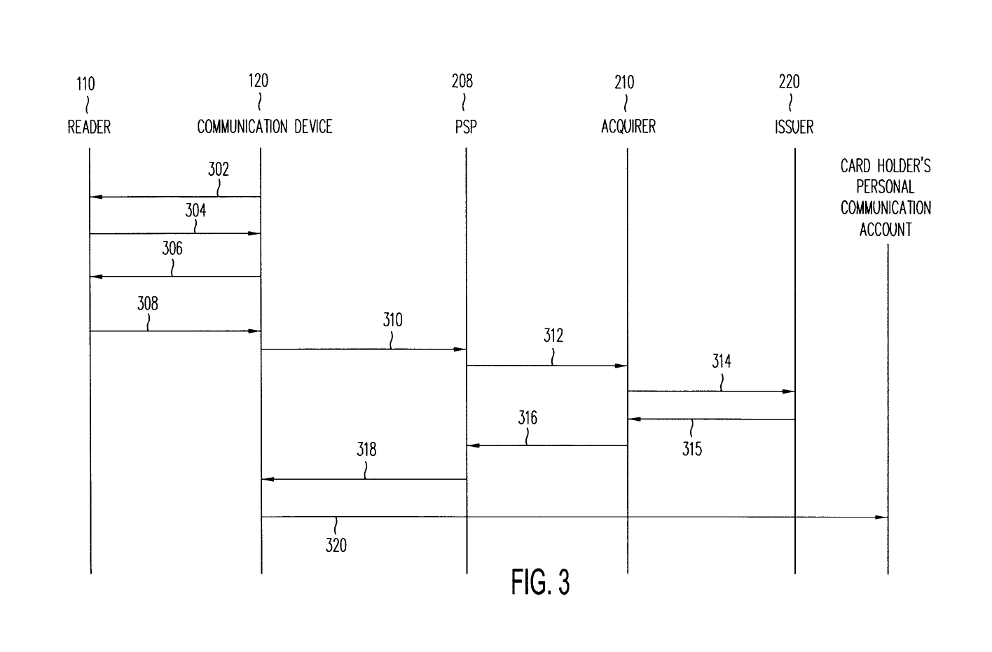

FIG. 3 is a signal diagram showing communications among the various entities of FIG. 2, according to one embodiment. At actions 302, 304, the card reader 110 and communication device 120 handshake and set up a data connection by Bluetooth or other short-range wireless protocol. In some embodiments, the communication device 120 initiates the connection, though the scope of embodiments is not so limited. In some embodiments, the application on the communication device 120 remembers the card reader 110 and establishes the data connection whenever the application detects the presence of the card reader 110.

At action 306, the application on the communication device 110 initiates a transaction by sending transaction information to the card reader 110. The transaction information may include, e.g., the amount of the transaction, the payee identification, account information of the payee, and the like.

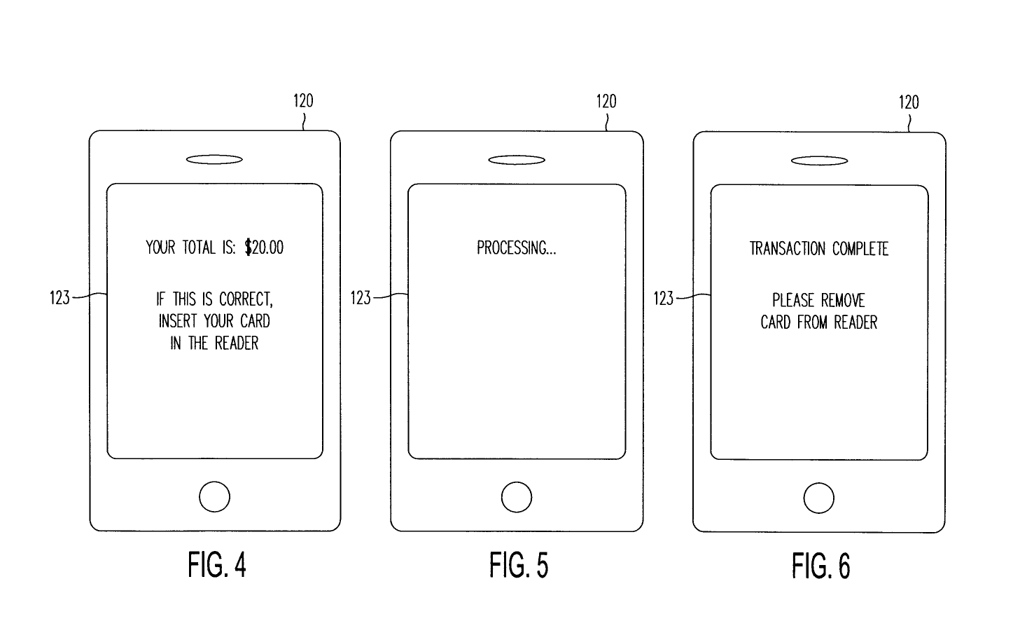

The application on communication device 110 may show a message on a screen, such as shown in FIG. 4, to prompt the merchant and the cardholder that payment is due and also to inform the cardholder of the amount of the transaction. The example message of FIG. 4 also prompts the cardholder to insert the card into the reader 110 if the cardholder believes the total to be correct. In some embodiments, it will be customary for the cardholder to hold the card reader 110 and for the merchant's employee to hold the communications device 120, though the merchant's employee may show the screen to the cardholder to verify the total.

Assuming that the cardholder agrees with the charges, the cardholder then inserts the card into the card reader 110 and enters a PIN on a keypad of the card reader 110. The card reader 110 provides power to the processor in the card and communicates with the card to facilitate the transaction. After the cardholder enters the PIN, the card reader 110 transfers data indicating the PIN to the card, and the card uses the PIN to verify use. If the PIN is not entered correctly within a limited number of tries, the card denies the transaction, and the flow ends. On the other hand, if the cardholder enters the correct the PIN, the card allows the transaction and proceeds to create an authorisation message which the card then encrypts using its private key, which has been unlocked by entering the PIN. This encryption (EMV Encryption) is performed on the card by its processor and within its secure environment, according to EMV standards. The payment authorization message includes, e.g., an authorization to pay the indicated amount to the merchant, an identification of the merchant, the merchant's account information, and the like. At action 308, the card reader 110 sends the encrypted authorization message to the communication device 120, which passes it to the PSP 208 at action 310.

In addition to the EMV Encryption, some embodiments include an additional level of encryption that secures the communication between the EMV reader 110 and PSP 208. EMV standards require encryption of only certain data such as the authorisation message; EMV Encryption using the card's relatively slow processor is not lightly undertaken, but this leaves some data unprotected. To alleviate this lack of protection, some embodiments add encryption for the data communications between the EMV reader 110 and the PSP 208. This additional encryption is referred to as Point to Point Encryption (P2PE) and uses a Derived Unique Key Per Transaction (DUKPT, standardized in ANSI X9.24). P2PE may also be applied to the authorization message from the card reader 110, on top of the EMV encryption performed on the card, so authorization messages and other data encrypted on the card receive an additional layer of protection. P2PE not only protects data that EMV standards do not require to be encrypted, but it also ensures that data from the card reader 110 can only be read by the PSP 208. P2PE thus ensures that a communication session between the card reader 110 and PSP 208 cannot be hijacked (subjected to external control), eavesdropped or altered by anyone other than PSP 208.

The EMV-encrypted data is decipherable only by the card issuer (the cardholder's bank) 220; such data passes unintelligibly through handheld communication device 120 and the app running on it, and through the PSP's 208 and the acquirer's 210 systems. It is significant for the PSP 208 and the acquirer 210 that an authorization message (albeit unreadable by them) is being sent to the issuer 220 (who can decide whether to honor it) because the passage of the authorization message sets up an expectation by the acquirer 210 and PSP 208 to receive payment (or a decline, error, etc.) in response from the issuer. Receipt of an unexpected payment out of the blue from an issuer, unconnected with any known prior authorization, would cause uncertainty for the acquirer 210 and PSP 208 because the unexpected payment would lack linkage to a known transactional context. Receipt of the authorization message by the PSP 208 can also trigger actions by the PSP 208, either before the PSP 208 sends on the message or in parallel. For example, the PSP 208 can perform its own analysis of the risk of the payment based on data available outside the encrypted authorization message such as the card number.

The screen on the handheld communications device 120 provides the user interface for the cardholder to carry out the EMV processes; the merchant's employee will hold up the screen for the cardholder to see in some embodiments. When the communication device 120 receives the encrypted authorization message, it and/or the PSP 208 may then perform additional processing of the authorization message to prepare it for sending. For instance, the application on the communication device 120 may add data specifically for use of PSP 208, but the communication device 120 is a relatively insecure environment, compared to the card reader 110 and the PSP 208, so the communication device 120 generally does not store or add crucial or confidential data. The communication device 120 functions mainly as a window into the card reader 110 and the PSP 208, and it operates the communication channel between the card reader 110 and the PSP 208, a channel that is encrypted in some embodiments using P2PE.

At action 312, the PSP 208 passes the authorization message to the acquiring bank 210. Servers at the acquiring bank 210 receive the authorization message from the PSP 208 and pass it through to the issuer 220, which decrypts and verifies the authentication of the message. The acquirer 210 and issuer 220 then process the card transaction in the manner prescribed by card association rules, which involves a request to the card issuer 220 to transfer funds to cover the payment at action 314. If the issuer 220 fails to honour the payment (for reasons such as insufficient funds available, card suspended or invalidated, etc.), then the issuer 220 declines the transaction and a decline message (at action 315) is passed through the acquirer 210 back to the PSP 208, and from there to the application on device 120 that operates the reader and interacts with the card holder 222 and merchant 224. Assuming that the issuing bank 220 approves the transaction, the issuing bank 220 sends an approval message (at action 315) and schedules settlement to the acquiring bank 210. The acquirer 210 sends a message at 316 to PSP 208 that settlement is scheduled.

After the cardholder has entered the correct PIN, the application on the communication device 120 may provide a message upon display 123, such as shown in FIG. 5. The application on device 120 may provide any appropriate message that facilitates the transaction.

At action 318, the PSP 208 then sends a confirmation message back to the device 120 to indicate that the transaction is complete and settlement has been made (or at least scheduled). The timing issues are complicated and vary by country. Settlement in Europe is usually on the next day, but full credit may be given the merchant on the day, i.e. the PSP 210 may anticipate the next day settlement when advised by the acquirer 210 that the payment is complete. However, the scope of embodiments is not limited to any particular method or timing of settlement.

Once the acquirer 210 notifies the PSP 208 that the payment is complete, the PSP causes the application on the device 120 to display a message, such as the message shown in FIG. 6, to indicate to the merchant and to the cardholder that the transaction is complete and to prompt the cardholder to remove the card from the device.

Further in this example embodiment, the merchant may enter contact information into the application running on the communication device for the cardholder in order for the cardholder to receive an electronic receipt. For instance, the merchant may enter a phone number, email address, or other information into the application so that the cardholder receives a receipt by email, text message, or other appropriate means.

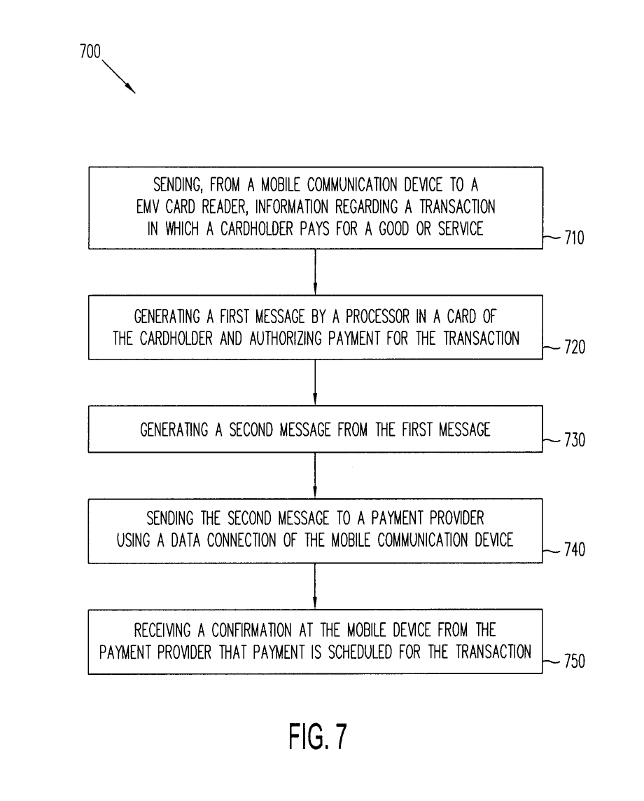

Various embodiments include methods for making payment for a transaction using the system shown in FIG. 1. FIG. 7 illustrates example method 700, adapted according to one embodiment, for making payments according to the principles discussed above in FIGS. 1-6. The example of FIG. 7 is from the perspective of the application on the communication device 120 and the EMV card reader 110, and the actions of FIG. 7 may be performed by one or more computer processors at the communication device 120 and/or by hardware at the EMV reader 110. One or more computer processors may execute code that provides the functionality of the application.

At block 710, the PSP sends, via the mobile communication device, to an EMV card reader, information regarding a transaction in which a cardholder pays for a good or service. An example is described above with respect to action 306 of FIG. 3. In this embodiment, the mobile communication device and the EMV card reader communicate wirelessly by, e.g., Bluetooth.

At block 720, the EMV card reader, on instruction from the PSP via the mobile communication device, initiates a first message, which is generated by the processor in a card of the cardholder and which authorizes payment for the transaction. An example is described above with respect to action 308 of FIG. 3.

At blocks 730 and 740, the EMV card reader generates a second message from the first message created by the card, and sends the second message to a PSP using the data connection of the mobile communication device. The second message may include additional encryption on top of the first message. An example is described above with respect to actions 310 and 312 of FIG. 3.

At block 750, the mobile communication device receives a confirmation from the payment service provider that settlement is scheduled for the transaction. An example is described above with respect to actions 316 and 318 of FIG. 3.

The scope of embodiments is not limited to the particular flow shown in FIG. 7. Rather, other embodiments may add, omit, rearrange, or modify one or more actions in accordance with a given design. For instance, other embodiments may include displaying messages to a human user throughout the transaction, such as shown in FIGS. 4-6. Furthermore, some embodiments include the mobile communication device being capable of processing non EMV card payments. Sometimes EMV processing rules allow this to happen, e.g., when there is a failure reading the chip, a non EMV card is presented (in which case swiping the card would be supported).

Additionally, some embodiments may include a Software Development Kit (SDK) that enables the application on the mobile communication device to interface with the card reader APIs and thereby control the card reader. In some instances, the SDK may be made available to third parties to build the same payment capability into their own applications.

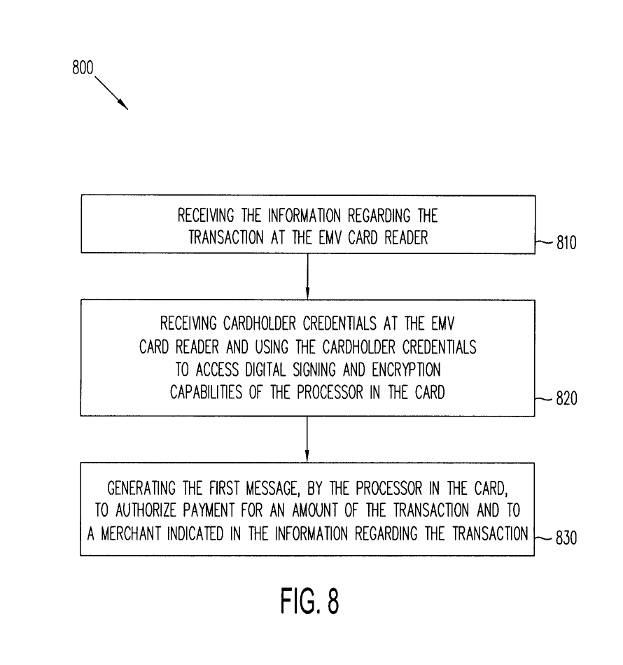

FIG. 8 is an illustration of example method 800, adapted according to one embodiment, for making payment for a transaction using the system of FIG. 1. The actions of FIG. 8 are from the perspective of the card reader (e.g., card reader 110 of FIG. 1). In some embodiments, the various actions are carried out by one or more computer processors executing computer code to provide the described functionality.

In block 810, the EMV card reader receives information regarding the transaction. An example is described above with respect to action 306 of FIG. 3.

In block 820, the EMV card reader receives cardholder credentials and uses the cardholder credentials to access the digital signing and encryption capabilities in the card. For instance, the card reader may receive user input to indicate a PIN. The card reader then verifies the authenticity of the card and unlocks the card's private key by applying the PIN digits.

In block 830, the card reader generates the first message, in concert with the processor in the card, to authorize payment for an amount of the transaction and to a merchant indicated in the information regarding the transaction. An example is described above with respect to action 308 of FIG. 3.

The scope of embodiments is not limited to the particular flow shown in FIG. 8. Rather, other embodiments may add, omit, rearrange, or modify one or more actions in accordance with a given design. For instance, method 800 may include interacting with a cardholder as the cardholder enters digits of the PIN. For example, the card reader may activate LEDs and/or make audible noises to indicate to the user that the cardholder's input is recognized.

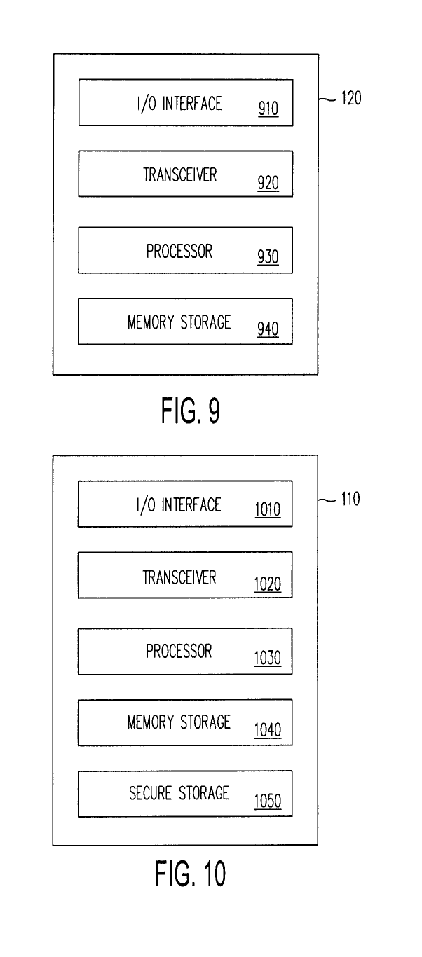

FIG. 9 is a simplified block diagram of an example handheld communication device 120. The handheld communication device 120 may be a portable personal electronic device, such as a smart phone, tablet computer, laptop, or other device with processing and communication capabilities sufficient to carry out the functions described above. The interface 910 is operable to receive an input from a user and communicate an output to the user. In an embodiment, the input/output interface 910 includes a visual display unit, for example a touch-sensitive screen. Input/output interface 910 may display a graphical interface, such as the interfaces shown in FIGS. 4-6.

The handheld communication device 120 includes a transceiver 920. The transceiver 920 is operable to electronically communicate with external devices. In an embodiment, the transceiver 920 is operable to wirelessly communicate with cellular towers, Wi-Fi access points or other network access points and infrastructure. The same, or a different, transceiver may be used to communicate with the card reader using an appropriate short-range wireless protocol, such as Bluetooth. The handheld communication device 120 also includes a computer processor 930 that is operable to execute computer instructions and a memory storage 940 that is operable to store the computer instructions and results of processing.

The memory storage 940 also contains a program module that is an embodiment of the application that interacts with the card reader and with the payment service provider over a network. The program module operates to provide actions such as communicating messages to and from the card reader, communicating messages to and from a payment service provider, and interacting with a human user, such as a card holder and an employee of a merchant. The program module may include one or more layers of APIs to communicate with the card reader 110 and to communicate over a network with payment providers.

FIG. 10 is a simplified block diagram of an example card reader 110 according to various aspects of the present disclosure. The card reader 110 may be configured according to the EMV rules noted above. For instance, the EMV rules provide guidelines about how a device should be constructed to prevent tampering, how the card reader should interact with the processor and private key in the card, and how the card reader should pass messages on to a payment provider.

In some examples, a notable feature is that the card reader 110 is minimal. For portability, the reader 110 can be stripped down to the EMV minimum, and the components included are realised in simple, minimal ways that take little space and consume little power.

The card reader 110 includes an input/output interface 1010. The interface 1010 is operable to receive an input from a user (e.g., by receiving key strokes on a keypad) and communicating to a user that the key strokes have been entered. In an embodiment, the input/output interface 1010 includes a visual display unit, for example LEDs, or an audio unit to make sounds.

The card reader 110 includes a transceiver 1020. The transceiver 1020 is operable to electronically communicate with external devices. In an embodiment, the transceiver 1020 is operable to wirelessly communicate with communication device 120, such as by Bluetooth, Wi-Fi, or other appropriate protocol. The card reader 110 also includes a computer processor 1030 that is operable to execute computer instructions and a memory storage 1040 that is operable to store the computer instructions. The card reader also has a separate, secured storage facility to hold the private key and protect it from discovery and misuse.

The memory storage 1040 also contains a firmware component that stores the operating system for the device. The operating system supplies functionality to the application running on the handheld communications device 120, which uses the reader's operating system for functions such as verifying a card, generating payment authorization messages, receiving payment confirmation, and the like. Such actions may be specified by the EMV standards discussed above. Additionally, the secure storage 1050 may be used for storing the private key and the mechanism for locking and unlocking it for use when the correct PIN is entered.

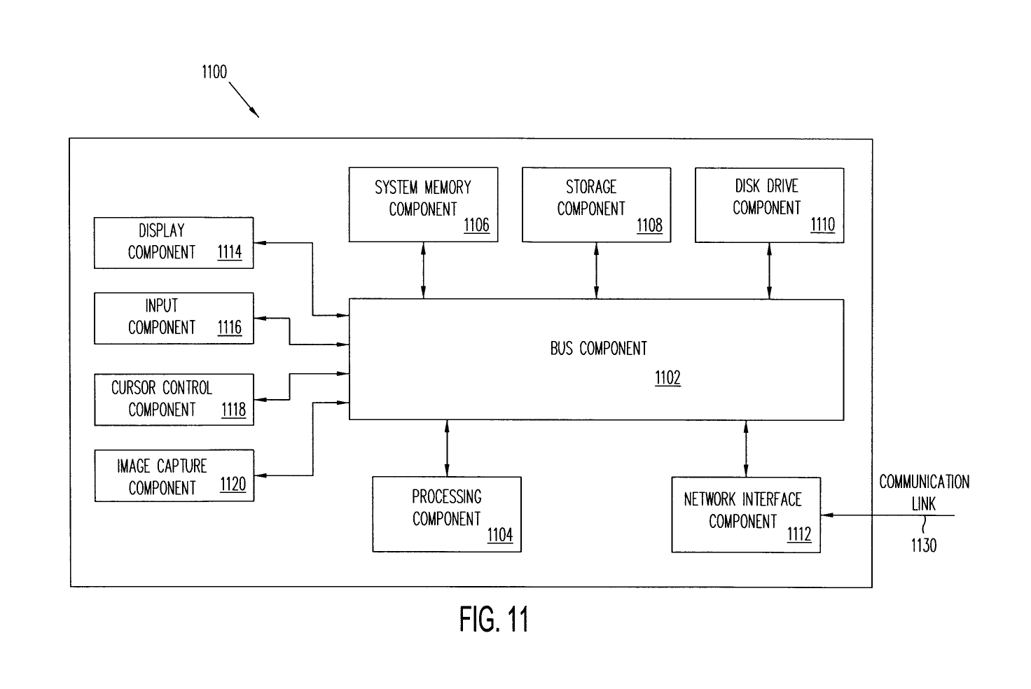

FIG. 11 is a block diagram of a computer system 1100 suitable for implementing various methods and devices described herein, for example, the various methods may be performed by a server computer or other type of computer that can be used as part of an account management or payment processing infrastructure at a PSP. Accordingly, it should be appreciated that such devices may be implemented as the computer system 1100 for communication with a network in a manner as follows.

In accordance with various embodiments of the present disclosure, the computer system 1100 includes a bus component 1102 or other communication mechanisms for communicating information, which interconnects subsystems and components, such as processing component 1104 (e.g., processor, micro-controller, digital signal processor (DSP), etc.), system memory component 1106 (e.g., RAM), static storage component 1108 (e.g., ROM), disk drive component 1110 (e.g., magnetic or optical), network interface component 1112 (e.g., modem or Ethernet card), display component 1114 (e.g., touch-screens, cathode ray tube (CRT) displays, or liquid crystal display (LCD)), input component 1116 (e.g., keyboard or touch-sensitive components operable to detect a touch by a human body), cursor control component 1118 (e.g., mouse or trackball), and image capture component 1120 (e.g., analog or digital camera). In one implementation, disk drive component 1110 may comprise an array having one or more disk drive components.

In accordance with embodiments of the present disclosure, computer system 1100 performs specific operations by processor 1104 executing one or more sequences of one or more instructions contained in system memory component 1106. Such instructions may be read into system memory component 1106 from another computer readable medium, such as static storage component 1108 or disk drive component 1110. In other embodiments, hard-wired circuitry may be used in place of (or in combination with) software instructions to implement the present disclosure.

Logic may be encoded in a computer readable, non-transitory medium, which may refer to any medium that participates in providing instructions to processor 1104 for execution. Such a medium may take many forms, including but not limited to, non-volatile media and volatile media. In various implementations, non-volatile media includes optical or magnetic disks, such as disk drive component 1110, and volatile media includes dynamic memory, such as system memory component 1106.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 1100. In various other embodiments of the present disclosure, a plurality of computer systems 1100 coupled by communication link 1130 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 1100 may transmit and receive messages, data, information and instructions, including one or more programs (i.e., application code) through communication link 1130 and communication interface 1112. Received program code may be executed by processor 1104 as received and/or stored in disk drive component 1110 or some other storage component for execution.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An electronic payment system provided by a mobile communication device, the system comprising:
a memory storing instructions for interacting with a EMV card reader to cause payment from an issuing bank associated with a cardholder to an acquiring bank of a merchant associated with the electronic payment processing system; and
one or more processors in communication with the memory configured to:
initiate a transaction by passing transaction information, including a transaction amount, to the EMV card reader;
receive encrypted payment authorization from the EMV card reader to process a payment from the issuing bank to the acquiring bank, wherein the one or more processors are in communication with the EMV card reader;
pass the encrypted payment authorization to the acquiring bank over a data connection; and
receive a confirmation of payment from the acquiring bank over the data connection.

2. The system of claim 1, wherein passing the encrypted payment authorization comprises:
send the encrypted payment authorization to a payment services provider, which further sends the encrypted payment authorization to the acquiring bank.

3. The system of claim 1 comprising a smartphone or tablet computer running an application to facilitate the transaction.

4. The system of claim 1, wherein the information regarding the transaction comprises:
a transaction amount and an identification of a merchant associated with the mobile communication device.

5. The system of claim 1, wherein the one or more processors are further configured to:
prompt a human user to insert an EMV card into the EMV card reader;
display an amount to be paid and requesting PIN entry (or other form of user authentication) by the human user;
record transaction information including the transaction amount, a currency, and a date of the transaction.

6. The system of claim 1, wherein the one or more processors are further configured to:
send an electronic receipt to the cardholder in response to the confirmation.

7. An electronic payment system comprising:
means for initiating a transaction by passing transaction information, including a transaction amount, to a EMV card reader from a mobile communication device;
means for receiving encrypted payment authorization from the EMV card reader to process a payment from an issuing bank to an acquiring bank;
means for passing the encrypted payment authorization from the mobile communication device to the acquiring bank over a wireless data connection; and
means for receiving a confirmation of payment from the acquiring bank over the wireless data connection.

8. The system of claim 7, wherein the means for passing the encrypted payment authorization comprises:
means for sending the encrypted payment authorization to a payment services provider, which send the encrypted payment authorization to the acquiring bank.

9. The system of claim 7 comprising a smartphone or tablet computer running an application to facilitate the transaction.

10. The system of claim 7, wherein the information regarding the transaction comprises:
a transaction amount and an identification of a merchant associated with the mobile communication device.

11. The system of claim 7, further comprising:
means for wirelessly coupling the system to the EMV card reader using a short-range protocol different than the wireless data connection.

12. The system of claim 7, further comprising:
means for displaying messages to the user during the transaction.

13. A method comprising:
sending, from a mobile communication device to a EMV card reader, information regarding a transaction in which a cardholder pays for a good or service;
receiving, by the mobile communication device from the EMV card reader, a first message generated by a processor in a card of the cardholder and authorizing payment for the transaction; sending the first message to an acquiring bank using a data connection of the mobile communication device; and
receiving a confirmation at the mobile device from the acquiring bank that payment is scheduled for the transaction.

14. The method of claim 13, further comprising:
adding a layer of encryption to the first message to generate a second message, the layer of encryption being decryptable by a payment service provider that further sends the first message to the acquiring bank.

15. The method of claim 13, wherein the information regarding the transaction comprises:
a transaction amount and an identification of a merchant associated with the mobile communication device.

16. The method of claim 13, wherein the first message is encrypted by the private key and processor in the card.

17. The method of claim 13, wherein the method is performed by an application running on the mobile communication device.

18. The method of claim 13, further comprising:
receiving the information regarding the transaction at the EMV card reader;
receiving cardholder authenticating data at the EMV card reader and using the cardholder authenticating data to access a payment capability of the processor in the card; and
generating the first message, by the processor in the card, to authorize payment for an amount of the transaction and to a merchant indicated in the information regarding the transaction.

19. The method of claim 18, wherein generating the first message includes encrypting the first message using a key kept by the processor in the card.

20. The method of claim 13, further comprising:
wirelessly coupling the mobile communication device to the EMV card reader using a short-range protocol different than the data connection.
